(19) United States
(12) Patent Application Publication
(10) Pub. No.: US 2026/0076364 A1
(43) Pub. Date: Mar. 19, 2026

(54) NON-AQUEOUS SOLUTION OF AGRICULTURAL ANTIBIOTICS

(71) Applicant: RITESH B. SHETH, HOLLY SPRINGS, NC (US)

(72) Inventor: RITESH B. SHETH, HOLLY SPRINGS, NC (US)

(21) Appl. No.: 19/327,313

(22) Filed: Sep. 12, 2025

Related U.S. Application Data
(60) Provisional application No. 63/694,399, filed on Sep. 13, 2024.
(60) Provisional application No. 63/724,482, filed on Nov. 25, 2024.

(51) Int. Cl. A01N 25/02; A01N 37/44; A01P 1/00; A01P 3/00

(52) U.S. Cl. CPC A01N 25/02; A01N 37/44; A01P 1/00; A01P 3/00

(57) ABSTRACT

The present disclosure generally relates to high concentration agricultural antibiotics in non-aqueous, low toxicity solutions, methods for making said non-aqueous low toxicity solutions, and methods for controlling disease thereby improving the growth and crop productivity of plants using said non-aqueous solution.

This non-provisional patent application claims all benefits under 35 U.S.C. § 119(e) of pending U.S. provisional patent application Ser. No. 63/694,399 filed 13 Sep. 2024 in the United States Patent and Trademark Office, entitled “High Concentration Low Volatility Solution of Agricultural Antibiotics”, and U.S. provisional patent application Ser. No. 63/724,482 filed 25 Nov. 2024 in the United States Patent and Trademark Office, entitled “Non-Aqueous Solution of Agricultural Antibiotics”, each of which are incorporated by reference in their respective entireties herein.

### FIELD OF THE DISCLOSURE

The present disclosure generally relates to antibiotic solutions, and more specifically pertains to one or more non-aqueous agricultural antibiotic solutions, methods for making said non-aqueous solution(s), and methods for controlling disease thereby improving the growth and crop productivity of plants using the aforementioned non-aqueous solution(s).

### DESCRIPTION OF THE PRIOR ART AND OBJECTIVES OF THE DISCLOSURE

As provided in Uptake, Translocation, and Stability of Oxytetracycline and Streptomycin in Citrus Plants, Huanglongbing (HLB) is the most destructive disease in the citrus industry. It is caused by a bacteria and is inhibited by antibiotics (such as oxytetracycline and streptomycin) via injection into the root and stem. Multiple injection companies inject the oxytetracycline hydrochloride in the dead tissue via drilling holes and using pressure to pump the aqueous solution into the tree. As provided in publication WO202324028A1, Invaio Sciences injects oxytetracycline hydrochloride (HCl) into the active vasculature of the plant using an aqueous solution of oxytetracycline hydrochloride with their patented injection technology. As provided in publication US2024099299A1, Thomas Johnson discloses that to have a substantially stable solution for at least 24 hours at 75° F. requires an aqueous solution defining a pH of 1.8 to 2.5. Arborbiotic by MGF Scientific Inc. teaches an example of an oxytetracycline HCl product that is diluted with water and acidified less than 48 hours prior to injection. As with most oxytetracycline products in the market (i.e. Bacastat Tree Injection, Mycoject Ultra, Fireline 17WP, Willowood Oxytet), the antibiotic is defined as a solid or capsule form to maintain stability. Terrier Systemic Antibiotics discloses a 4.3% solution in Tetrahydrofurfuryl alcohol which defines a low flash point and high volatility in addition to toxicity/regulatory concerns compared with other formulations known in the marketplace.

Agriculturally, active ingredients are often provided in the form of concentrates suitable for dilution with water. Many forms of agricultural concentrates are known in the public domain and these often consist of the active ingredient and a carrier, which in turn may include various components. Water-based concentrates are obtained by dissolving, emulsifying and/or suspending agriculturally active technical materials in water. Due to the relatively complex supply chain for crop protection agents, such concentrate formulations may be stored for long periods of time and may be subjected during storage and shipping to extreme temperature variations, high-shear and repetitive vibration patterns. Such supply chain conditions often increase the likelihood of formulation failure due to, for example, water-mediated degradation and stability problems.

Accordingly, the efficient use of aqueous systems with certain agrochemicals and crop protection agents with active technical materials is disfavored due to their poor chemical stability when exposed to water during storage. Typically, hydrolysis is the most common water-mediated degradation mechanism; however, agricultural concentrates with water-sensitive active ingredients are also subject to oxidation, dehalogenation, bond cleavage, and other forms of degradation on exposure to water.

In some cases it may be desirable to combine different agrochemicals to provide a single formulation taking advantage of the additive properties of each separate technical material and optionally, an adjuvant or combination of adjuvants that provide optimum biological performance. For example, transportation and storage costs can be minimized by using a formulation in which the concentration of the active agrochemical(s) is as high as is practicable and in which any desired adjuvants are “built-in” to the formulation as opposed to being separately mixed inside an applicator storage device such as a spray tank. The higher the concentration of the active agrochemical(s) however, the greater is the probability that the stability of the formulation may be disturbed, or that one or more components may phase separate.

Another challenge arises where a user of an agrochemical liquid concentrate formulation dilutes the formulation in water (for example in a spray tank) to form a dilute aqueous spray composition. Such agrochemical spray compositions are widely used, but their performance sometimes may be of limited efficacy due to the tendency for certain agrochemicals to degrade in a spray tank on exposure to water. For example, agrochemical breakdown can increase with increasing alkalinity and water temperature, and with the length of time the spray composition is left in the tank.

Considering the variety of conditions and special situations under which agrochemical liquid concentrate formulations are stored, shipped and used around the world, there remains a need for concentrate formulations of agrochemicals, including water sensitive agrochemicals that provide stability benefits under one or more of those conditions and situations. There is a further need for such formulations defining high loading that are stable before being diluted under a wide range of field conditions.

Publications IN202121061456A and IN202221005700A document the stabilizing of liquid agrochemical compositions of oxytetracycline and oxytetracyline/tert-butyl4-[(e)-1(1,3-dimethyl-5-phenoxypyrazol-4-yl)methylidene amino]benzoate using oil dispersions. Publication US2009053271A1 documents stabilizing oxytetracycline as a reverse phase microcapsule suspension in water. Publication US2010234227A1 documents stabilizing oxytetracycline as a microemulsion concentrate. Publication CN104671945A documents stabilization with multiple co-formulants as a powder. Publication CN1048800152A documents the dissolution of oxytetracycline for use in veterinary medicine in N, N-Dimethylformamide, a low volatile toxic solvent, with addition of up to 5% water to increase the activity of oxytetracycline in the medicine.

Oxytetracycline hydrochloride is currently restricted for use in a formulation using higher volatility toxic solvents and/or as emulsions, dispersions, powders, that must be diluted in aqueous solutions with short shelf lives. Therefore, there is an unmet need in the art for a stable mixture of these antibiotics in a soluble liquid formulation for commercial use that provides at least a year long shelf life and has improved (i.e. lower) toxicity that can be injected into agricultural plants such as citrus trees. Thus, in view of the problems and disadvantages associated with prior art formulations and delivery methods, the present disclosure was conceived and one of its objectives is to provide an antibiotic formulation that is efficient to manufacture and relatively simple to administer.

It is another objective of the present disclosure to provide a non-aqueous solution of agricultural antibiotics including an antibiotic, and at least one polar or semi-polar solvent.

It is still another objective of the present disclosure to provide a non-aqueous solution of agricultural antibiotics including oxytetracycline, oxytetracycline hydrochloride, oxytetracycline salt, and at least one polar solvent.

It is yet another objective of the present disclosure to provide a non-aqueous solution of agricultural antibiotics including oxytetracycline hydrochloride between about 0.01 to 10 wt % and an organic solvent present on the EPA's Inert Ingredients Approved for Use in Minimum Risk Pesticide Products (formerly designated as the EPA List 4A/4B; see U.S. Environmental Protection Agency: List of Inert Pesticide Ingredients, August 2004).

It is a further objective of the present disclosure to provide a non-aqueous solution of agricultural antibiotics including oxytetracycline hydrochloride between about 0.01 to 5.0 wt % and a solvent selected from the group consisting of ethanol, n-propanol, iso-propanol, butanol, glycerol, propylene glycol, and polyethylene glycol, defining a molecular weight from 200 to 400.

It is still a further objective of the present disclosure to provide a non-aqueous solution of agricultural antibiotics including oxytetracycline hydrochloride between about 0.01 to 5.0 wt % and a solvent selected from the group consisting of solketal, n, n-dimethyloctanamide methyl-5-dimethylamino-2-methyl-5-oxopentanoate, polyethers, dibasic esters, and mixtures thereof of.

It is yet a further objective of the present disclosure to provide a non-aqueous solution of agricultural antibiotics including oxytetracycline hydrochloride between about 0.01 to 5.0 wt % and a solvent selected from the group consisting of EPA List 4A/4B listed solvents, further including one or more surfactants, antifoams, cellulose, and/or preservatives.

Various other objectives and advantages of the present disclosure will become apparent to those skilled in the art as a more detailed description is set forth below.

### SUMMARY OF THE PRESENT DISCLOSURE

The present disclosure is directed to a non-aqueous solution of: 1) an antibiotic and 2) at least one polar or semi-polar organic solvent. The present disclosure further includes methods for making said non-aqueous solution, and methods for controlling disease thereby improving the growth and crop productivity of plants using said non-aqueous solution. The present disclosure is directed to methods for controlling disease and thereby improving the growth and crop productivity of plants such as citrus trees by introducing antibiotics, such as oxytetracycline hydrochloride, to the tissue of the plant using polar and/or semi-polar organic solvent(s). In the preferred method of administering the subject matter of the disclosure, an antibiotic in a predetermined amount effective to produce the desired effect, e.g., controlling citrus greening, is dissolved in polar and/or semi-polar organic solvent(s) and applied as a solution to the plant tissue.

The non-aqueous solution containing one or more antibiotics has a potential for higher concentrations, greater shelf life, lower toxicity, and can be injected directly compared to what is taught in the art. The preferred non-aqueous solution with lower toxicity provides a more cost effective solution to the marketplace. The greater shelf life allows the injector to be prefilled and provide greater time for uptake without the fear of losing activity of the antibiotic. The ability to directly inject with low toxicity removes a step of having to dissolve the stable oxytetracycline hydrochloride in acidic solutions which has a toxic impact on the injected plant due to the low pH (i.e. pH 5 or lower) in the vasculature system.

### BRIEF DESCRIPTION OF THE DRAWINGS

FIG. 1 shows the stability of various concentrations of oxytetracycline hydrochloride in a variety of solvents in Table 1;

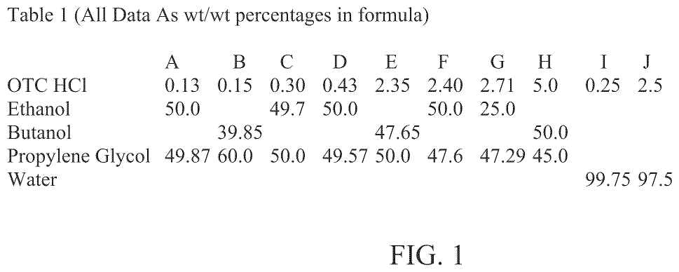

FIG. 2 pictures a table of the accelerated storage stability test of oxytetracycline hydrochloride dissolved in the polar/semi-polar solvents and then heated over time;

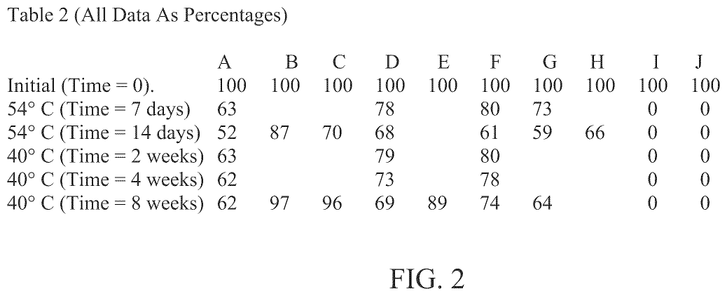

FIG. 3 depicts the percentage of oxytetracycline hydrochloride dissolved in a variety of solvents in Table 3;

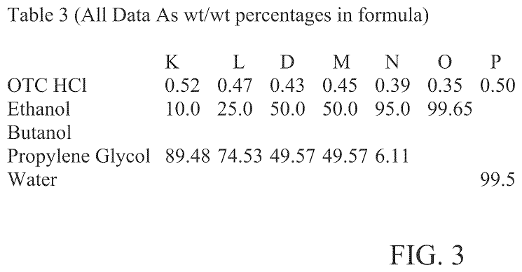

FIG. 4 demonstrates a table of the accelerated storage stability test of oxytetracycline hydrochloride dissolved in the polar/semi-polar solvents and then heated over time;

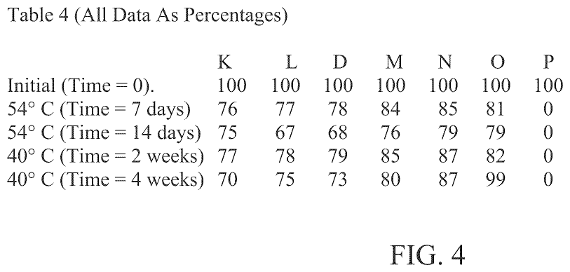

FIG. 5 illustrates the percentage of oxytetracycline hydrochloride dissolved in a variety of solvents in Table 5;

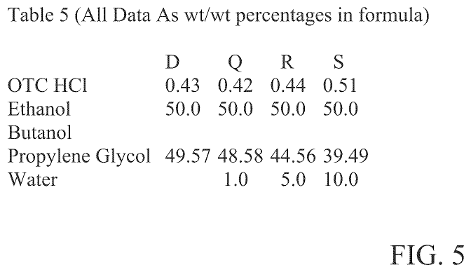

FIG. 6 features a table of the accelerated storage stability test of oxytetracycline hydrochloride dissolved in the polar/semi-polar solvents and then heated over time;

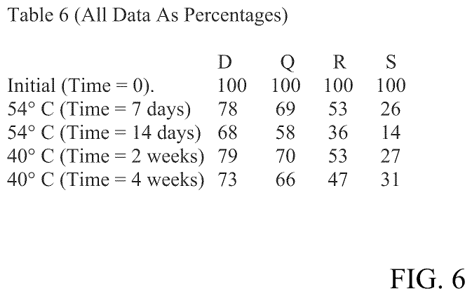

FIG. 7 shows the percentage of oxytetracycline hydrochloride dissolved in a variety of solvents in Table 7; and

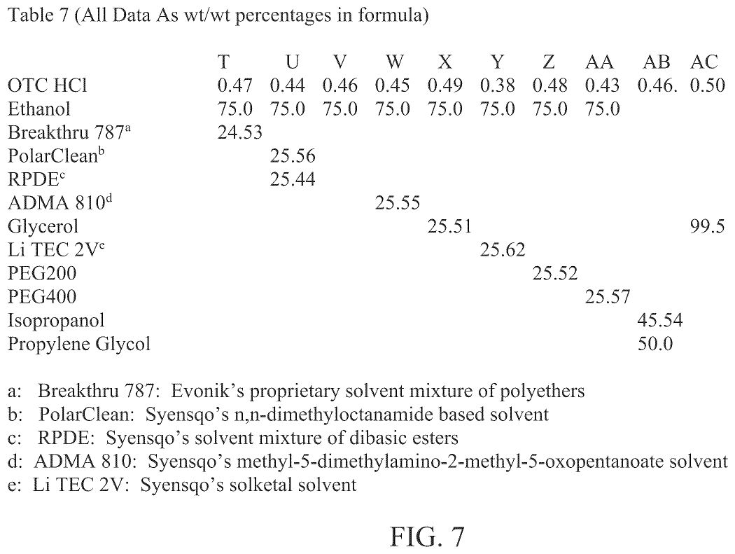

FIG. 8 illustrates a table of the accelerated storage stability test of oxytetracycline hydrochloride dissolved in the polar/semi-polar solvents and then heated over time;

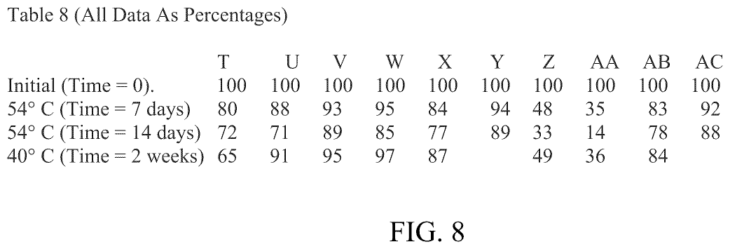

### DETAILED DESCRIPTION OF THE PREFERRED EMBODIMENT AND OPERATION OF THE DISCLOSURE

Various exemplary embodiments of the present disclosure are described below. Use of the term “exemplary” means illustrative or by way of example only, and any reference herein to “the disclosure” is not intended to restrict or limit the disclosure to exact features or step of any one or more of the exemplary embodiments disclosed in the present specification. References to “exemplary embodiment”, “one embodiment”, “an embodiment”, “various embodiments”, and the like may indicate that the embodiment(s) of the disclosure so described may include a particular feature, structure, or characteristic, but not every embodiment necessarily incudes the particular feature, structure, or characteristic. Further, repeated use of the phrase “in one embodiment”, “in an exemplary embodiment”, or “in an alternative embodiment” do not necessarily refer to the same embodiment, although they may.

It is also noted that terms like “preferably”, “commonly”, and “typically” are not utilized herein to limit the scope of the disclosure or to imply that certain features are critical, essential, or even important to the structure or function of the disclosure. Rather, these terms are merely intended to highlight alternative or additional features that may or may not be utilized in a particular embodiment of the present disclosure.

The present disclosure is described more fully hereinafter with reference to the accompanying tables, in which one or more exemplary embodiments of the disclosure are shown, described, or otherwise represented. Like numbers used herein refer to like elements throughout. The disclosure may, however, be embodied in many different forms and should not be construed as limited to the embodiments set forth herein; rather, these embodiments are provided so that this disclosure will be operative, enabling, and complete. Accordingly, the particular formulations disclosed are meant to be illustrative only and not limited as to the scope of the disclosure, and any and all equivalents thereof. Moreover, many embodiments such as adaptations, variations, modifications, and equivalent formulations will be implicitly disclosed by the embodiments described herein and fall within the scope of the instant disclosure.

Although specific terms are employed herein, they are used in a generic and descriptive sense only and not for the purposes of limitation. Unless otherwise expressly defined herein, such terms are intended to be given their broad, ordinary, and customary meaning not inconsistent with that applicable in the relevant industry and without restriction to any specific embodiment hereinafter described. As used herein, the article “a” is intended to include one or more items. Where only one item is intended, the terms “one and only one”, “single”, or similar language is used. When used herein to join a list of items, the term “or” denotes at least one of the items but does not exclude a plurality of items of the list.

For exemplary methods or processes of the disclosure, the sequence, formulation and/or arrangement of steps described herein are illustrative and not restrictive. Accordingly, it should be understood that, although steps of various processes or methods may be shown and described as being in a sequence or temporal arrangement, the steps of any such processes or methods are not limited to being carried out in any particular sequence or arrangement, absent an indication otherwise. Indeed, the steps in such processes or methods generally may be carried out in various different sequences and arrangements while still falling within the scope of the present disclosure.

Additionally, any references to advantages, benefits, unexpected results, or operability of the present disclosure are not intended as an affirmation that the disclosure has previously been reduced to practice or that any testing has been warranted. Likewise, unless stated otherwise, use of verbs in the past tense (present perfect or preterit) is not intended to indicate or imply that the disclosure has previously been reduced to practice or that any testing has been warranted.

For a better understanding of the disclosure and its manufacture, operation, and use, turning now to the description and tables contained herein, the preferred non-aqueous solution of the present disclosure may include: 1) an antibiotic, and 2) at least one polar and/or semi-polar organic solvent with a comparatively low toxicity. Herein are also disclosed methods for making one or more embodiments of said non-aqueous low toxicity solution and methods for controlling disease thereby improving the growth and crop productivity of plants using said non-aqueous solution. Embodiments of the present disclosure include methods by which antibiotics may be manipulated through the addition of said high non-aqueous low toxicity solution by application to plant tissue for example citrus tree tissue.

As used herein, it should be understood that the term “non-aqueous” may include small amounts of water, preferably less than 5 wt. %, preferably less than 4 wt. %, preferably less than 3 wt. %, preferably less than 2 wt. %, preferably less than 1 wt. %, and preferably less than 0.5 wt. %. However, it is most preferred that water is not otherwise added to the present non-aqueous solution; provided however that it should be understood that even with no otherwise added water, that some trace amounts may be present in a non-aqueous formulation (+/−0.1 wt. %) and still be within the scope of the instant disclosure. Further, as used herein, a solution is considered “stable” if ten percent (10%) or more of the antibiotic material remains in solution over a predetermined period of time at a predetermined temperature as determined by the EPA Office of Pesticide Programs (OPP) guidelines relating to “Accelerated Storage Stability and Corrosion Characteristics Study Protocol”. As will be described in greater detail below, the preferred temperature to determine the stability of a solution is 54° C. for the period of two weeks and/or 40° C. for a period of eight weeks. This equates to a formulation shelf life at room temperature for approximately two years at “room temperature” (considered herein as about 25° C., +/−3° C.). Therefore, if 10% or more of the antibiotic material remains in solution when exposed to 54° C. for a period of 2 weeks, and/or 40° C. for a period of 8 weeks, the solution is considered “stable” as the term is used herein. It should be noted that this novel stability may be achieved without acidification of the resulting solution.

### Antibiotics

As noted above, the preferred non-aqueous solution of the present disclosure may include one or more embodiments of antibiotic. While the antibiotic provided in one or more embodiments of non-aqueous solution may be any effective agrochemical capable of reducing the detectable amount of bacteria in a given plant system, the preferred antibiotic for use as a component of one or more embodiments of non-aqueous solution for injection is typically selected from oxytetracycline, oxytetracycline salts, streptomycin, streptomycin salts, antibiotic precursors, derivatives, and mixtures thereof.

One or more embodiments of antibiotic, preferably oxytetracycline hydrochloride, is present in the preferred embodiment of non-aqueous low toxicity solution in an amount such that the antibiotic is between about 0.01 to 40 wt. % (+/−0.05 wt. %) of the total solution, and more preferably between 0.01 to 30 wt. % of the total solution, and more preferably between 0.01 to 10 wt. % of the total solution and most preferably between 0.01 wt. % and 5 wt. % of the total solution. In an alternative embodiment, the antibiotic is preferably defined as kasugamycin or kasugamycin salt in a concentration of about 0.01 to 10 wt. % (+/−0.05 wt. %) of the total solution.

### Polar and Semi-polar Low Toxicity Solvents

A wide variety of one or more low toxicity organic solvents may be present in one or more embodiments of the preferred embodiment of the preferred low toxicity non-aqueous solution. One preferred embodiment of the present non-aqueous solution may include low toxicity organic solvents comprising one or more Environmental Protection Agency (EPA) so-called List 4 (4A/4B) solvents that contain inert ingredients defined to have “Minimal Concern.” The EPA's List of Inert Pesticide Ingredients is hereby incorporated by reference in its entirety herein. Examples of such solvents found in list 4 include ethanol, butanol, propylene glycol, glycerol, and polyethylene glycol. Other low toxicity solvents include Polyethylene Glycol 200-400, and/or at least one lactamide, preferably, n, n-dimethyl lactamide and/or at least one pentanoate, preferably, methyl-5-dimethylamino-2-methyl-5-oxopentanoate, or a mixture thereof with a list 4 solvent. Further acceptable low toxicity solvents may include solketal, and/or at least one octanamide, preferably, n, n-dimethyloctanamide and/or at least one pentanoate, preferably, methyl-5-dimethylamino-2-methyl-5-oxopentanoate or Rhodiasolv ADMA 810, and/or at least one set of polyethers, preferably, Evonik's Breakthru 787, and/or at least one mixture of dibasic esters, preferably, Rhodiasolv RPDE, or mixture(s) thereof of one or more of the aforementioned low toxicity solvents. Additionally, or in the alternative, it may be possible to group one or more of the aforementioned solvents into a larger group with other solvents, for example (but not by way of limitation) a first solvent selected from a group such as alcohols and a second solvent selected from a group such as glycols. In one or more embodiments of non-aqueous solutions, one or more member(s) from one or more of such groups of solvents are combined in said solution, for example (but not intended as a limitation) combining ethanol and glycerol.

### Additional Ingredients Includes/Excluded

A preferred embodiment of the preferred embodiment of non-aqueous solution includes the addition of one or more surfactants, antifoams, and/or preservatives up to about 20 wt. % (+/−5%), as known to those of skill in the art. The surfactants may include, but are not limited to, the group consisting of carboxylates, sulfonates, natural oils, alkylamides, arylamides, alkylphenols, aryl phenols, ethoxylated alcohols, polyethylene, carboxylic esters, poly alkyl glycol esters, anhydro sorbitols, glycol esters, carboxylic amides, monoalkanolamine, polyethylene fatty acid amides, polysorbates, cyclodextrins, sugar based, silicone based, polyalkylated alcohols, and alkylaryl ethoxylates. In a preferred embodiment, the non-aqueous solution is formed of only the plant growth regulator(s), one or more optional mineral(s), surfactant(s), and the polar and semi-polar organic solvent(s) with an acknowledgement as to the trace presence of any impurities inherent therein.

In an alternate, but still preferred embodiment of non-aqueous solution, the non-aqueous solution includes a single EPA list 4 solvent, that is, a single polar or semi-polar organic solvent. As previously indicated, this non-aqueous solution may include small amounts of water, preferably less than 5 wt. % of the total solution, more preferably less than 4 wt. % of the total solution, more preferably less than 3 wt. % of the total solution, more preferably less than 2 wt. % of the total solution, more preferably less than 1 wt. % of the total solution, preferably less than 0.5 wt. % of the total solution, and most preferably no otherwise added water.

### Method of Making

One or more embodiments of the non-aqueous solution is configured for systemic delivery to a plant to treat a bacterial disease inflicting the plant, for example Huanglongbing in a citrus tree. Multiple methods exist for the injection of the preferred embodiment of non-aqueous solution into the vascular system of a plant (not shown). As would be understood, tools including (but not limited to) drills, syringe with needles, or other injecting devices may be utilized to create access to the plant vascular system followed by delivery of one or more embodiments of non-aqueous solution via atmospheric pressure or pressurized canister/pump (not shown). A preferred embodiment of non-aqueous solution is generally produced by dissolving the antibiotic in at least one low toxicity organic solvent at a temperature up to the boiling point of the polar and/or semi-polar organic solvent, more preferably below 75° C., more preferably below about 50° C. (+/−5%), and most preferably below 50° C.

### Application to Plants

In a preferred embodiment of non-aqueous solution, the non-aqueous solution is injected in the root or stem of the plant either at a previously determined concentration or further diluted with the above selected polar, semi-polar, and/or low toxicity solvents.

### Examples

One or more of the following examples are intended to illustrate one or more embodiments of the present disclosure, and to teach one of ordinary skill in the art how to make and use embodiment(s) of the non-aqueous solution disclosed herein. They are not intended to limit the disclosure or its protection in any way. The EPA guidelines on Stability that issued on Nov. 16, 2012 to the Office of Pesticide Programs (OPP) relating to “Accelerated Storage Stability and Corrosion Characteristics Study Protocol” were followed. In view of the foregoing, said EPA guidelines are incorporated herein in their respective entirety. As provided in the EPA guidelines, accelerated storage stability can be used to fulfill EPA data requirements. OPP has determined that this study, conducted for fourteen (14) days at an elevated temperature (54° C.) or 8 weeks at an elevated temperature (40° C.), provides adequate data in certain circumstances to allow the EPA to make a regulatory finding regarding the stability of the product and the effect of the formulation on the product packaging equivalent to two (2) years of storage shelf stability. Furthermore, half of the time tested per temperature equates to one (1) year of storage shelf stability.

### Example #1 Stability of Various Concentrations of Oxytetracycline Hydrochloride in Inventive Solvents

Ten formulas of non-aqueous solution were prepared by dissolving oxytetracycline hydrochloride in a predetermined solvent at room temperature without introducing any additional water. The specific combination of the oxytetracycline hydrochloride and given solvent is presented as a function of weight/weight percentages of the total solution defining the respective formulation in Table 1. The formulas were then placed for Accelerated Storage Stability at either/both 54° C. and/or 40° C. The results are depicted in Table 2.

As Table 2 demonstrates, all formulas where oxytetracycline hydrochloride is dissolved in the polar/semi-polar solvents demonstrate significantly improved storage stability compared to those formulations that were dissolved in water as taught in the art. In addition, as oxytetracycline hydrochloride is known in literature to be temperature sensitive, lower temperatures demonstrate superior stability to those tests performed at higher temperatures; thereby, room temperature over an extended period of time, for example one (1) year, would further demonstrate even greater stability.

### Example #2 Stability of Oxytetracycline Hydrochloride in Various Ratios of Inventive Solvents

Seven formulas of non-aqueous solution were prepared by dissolving oxytetracycline hydrochloride in a predetermined solvent at room temperature without introducing any additional water. The specific combination of the oxytetracycline hydrochloride and given solvent is presented as a function of weight/weight percentages defining the respective formulation in Table 3. The formulas were then placed for Accelerated Storage Stability at either/both 54° C. and/or 40° C. The results are depicted in Table 4.

Table 4 illustrates that all formulas where oxytetracycline hydrochloride is dissolved in the polar/semi-polar solvents to various percentage ratios as a function of temperature and time, demonstrating significantly improved storage stability compared to the formulation dissolved in water as is known in the art.

### Example #3 Stability of Oxytetracycline Hydrochloride in Inventive Solvents with Added Water

Three formulas of non-aqueous solution were prepared by dissolving oxytetracycline hydrochloride in a predetermined solvent at room temperature, including the introduction of a predetermined, non-trace amount of water. The specific combination of the oxytetracycline hydrochloride and given solvent is presented as a function of weight/weight percentages defining the respective formulation in Table 5. The formulas were then placed for Accelerated Storage Stability at either/both 54° C. and/or 40° C. The results are depicted in Table 6. As Table 6 clearly illustrates, all formulas with water introduced into the formulation reduces storage stability (compare with results outlined in Table 4).

### Example #4 Stability of Oxytetracycline Hydrochloride in Inventive, Low-Toxicity Solvents

Ten formulas of non-aqueous solution were prepared by dissolving oxytetracycline hydrochloride in a predetermined solvent at room temperature without introducing any additional water. The specific combination of the oxytetracycline hydrochloride and given solvent is presented as a function of weight/weight percentages defining the respective formulation in Table 7. The formulas were then placed for Accelerated Storage Stability at either/both 54° C. and/or 40° C. The results are depicted in Table 8.

As Table 8 shows, all formulas where oxytetracycline hydrochloride is dissolved in the polar/semi-polar solvents demonstrate significant improvement if storage stability compared to those dissolved in water as is known in art.

The illustrations and examples provided herein are for explanatory purposes and are not intended to limit the scope of the appended claims.

I claim:

1. A non-aqueous solution comprising:
an antibiotic defined as oxytetracycline from 0.01 to 10 wt. %;
at least one solvent selected from a group consisting of ingredients listed on an EPA List 4A/4B and low toxicity solvents;
optionally at least one mineral, optionally at least one surfactant, optionally at least one antifoam, optionally at least one preservative, and optionally combinations thereof; and
less than 5 wt. % water;
wherein said non-aqueous solution is stable.

2. The non-aqueous solution of claim 1, wherein the oxytetracycline is defined as an oxytetracycline salt.

3. The non-aqueous solution of claim 2, wherein the oxytetracycline salt is further defined as oxytetracycline hydrochloride.

4. The non-aqueous solution of claim 1, wherein the at least one solvent is selected from a group consisting of ethanol, glycerol, iso-propanol, n-propanol, propylene glycol, polyethylene glycols ranging from a molecular weight of 200 to 400, butanol, ethoxylated alcohols, and combinations thereof.

5. The non-aqueous solution of claim 1, wherein the at least one solvent is selected from a group of low toxicity solvents consisting of solketal, n, n-dimethyloctanamide methyl-5-dimethylamino-2-methyl-5-oxopentanoate, polyethers, dibasic esters, and combinations thereof.

6. The non-aqueous solution of claim 1, wherein the at least one solvent is a combination selected from ingredients listed on an EPA List 4A/4B and low toxicity solvents.

7. The non-aqueous solution of claim 1, wherein the at least one surfactant defines a wt. % of the non-aqueous solution of up to about 20 wt. %.

8. The non-aqueous solution of claim 1 further comprising about 5 wt. % cellulose.

9. The non-aqueous solution of claim 1, wherein the non-aqueous solution is configured to be directly injected into a tree to counteract a bacterial or fungal disease.

10. The non-aqueous solution of claim 1, wherein the non-aqueous solution is further diluted to a predetermined concentration with the at least one solvent and configured to be injected into a tree to counteract a bacterial or fungal disease.

11. The non-aqueous solution of claim 1, wherein the non-aqueous solution is configured to be injected systemically into a rootstock or a trunk of a tree or a vine.

12. The non-aqueous solution of claim 1, wherein the non-aqueous solution is configured to be injected systemically into a vascular network of a tree or a vine.

13. A non-aqueous solution consisting substantially of:
an antibiotic defined as oxytetracycline from between 0.01 to 10 wt. %;
at least two solvents selected from a group consisting of: ethanol, butanol, propylene glycol, glycerol, polyethylene glycol, and combinations thereof;
optionally at least one mineral, optionally at least one surfactant, optionally at least one antifoam, optionally at least one preservative, and optionally combinations thereof; and
less than 5 wt. % water.

14. The non-aqueous solution of claim 13, wherein the non-aqueous solution is stable for two weeks at 54° C. or eight weeks at 40° C. or two years at about 25° C.

15. The non-aqueous solution of claim 14, wherein the at least two solvents are defined as ethanol and glycerol.

16. The non-aqueous solution of claim 15, wherein the oxytetracycline is defined as an oxytetracycline salt.

17. The non-aqueous solution of claim 16, wherein the oxytetracycline salt is defined as an oxytetracycline hydrochloride.

18. The non-aqueous solution of claim 15, wherein the at least one surfactant defines a wt. % of the non-aqueous solution of about 20 wt. %.

19. The non-aqueous solution of claim 15, wherein the oxytetracycline is present in said non-aqueous solution from 0.01 to 10 wt. %.

20. The non-aqueous solution of claim 19, wherein the oxytetracycline defined as oxytetracycline hydrochloride and is present in said non-aqueous solution from 0.01 to 5 wt. %.
